(19) United States
(12) Patent Application Publication
(10) Pub. No.: US 2024/0325984 A1
(43) Pub. Date: Oct. 3, 2024

(54) SYSTEMS AND METHODS FOR HIGH-SALINITY ELECTRODIALYSIS WITH RATIONALLY-DESIGNED ION-EXCHANGE MEMBRANES

(71) Applicant: THE TRUSTEES OF COLUMBIA UNIVERSITY IN THE CITY OF NEW YORK, New York, NY (US)

(72) Inventors: Ngai Yin YIP, Chatham, NJ (US); Sanat K. KUMAR, New York, NY (US); Yuxuan HUANG, New York, NY (US); Marshall TEKELL, New York, NY (US)

(73) Assignee: THE TRUSTEES OF COLUMBIA UNIVERSITY IN THE CITY OF NEW YORK, New York, NY (US)

(21) Appl. No.: 18/618,274

(22) Filed: Mar. 27, 2024

Related U.S. Application Data
(60) Provisional application No. 63/454,809, filed on Mar. 27, 2023.

(51) Int. Cl. B01D 67/00; B01D 61/46; B01D 71/28

(52) U.S. Cl. CPC B01D 67/00111; B01D 61/46; B01D 71/281

(57) ABSTRACT

Cation exchange membranes are prepared via facile methods to control sulfonation of polystyrene repeat units. An amount of sulfuric acid is reacted with an acetic anhydride to form an amount of acetyl sulfate. The acetyl sulfate is then added to a known concentration of polystyrene units in boiling dichloromethane (DCM) to form sulfonated polystyrene random copolymers, including a random distribution of sulfonated polystyrene repeats and unsulfonated polystyrene repeats, with sulfonation levels between about 0.07 and about 0.225. The sulfonation level can be controlled by adjusting reaction times, reaction temperatures, and sulfuric acid loading in the reaction mediums. These membranes, neutralized via alkali metals, exhibit high charge densities and low hydration degrees, and maintain high permselectivity under various high solution concentrations. The membranes can expand the operating range of ion-exchange membranes (IEMs) and enable numerous additional applications, including high-salinity electrodialysis, improved efficiency of the chloralkali process, water electrolyzers, fuel cells, etc.

### CROSS REFERENCE TO RELATED APPLICATION(S)

This application claims the benefit of U.S. Provisional Application No. 63/454,809, filed Mar. 27, 2023, which is incorporated by reference as if disclosed herein in its entirety.

### BACKGROUND

Ion-exchange membranes (IEMs) are charged membranes that selectively retain like-charged ions, e.g., anions, cations, etc., while allowing the permeation of oppositely charged ions, i.e., counterions. IEMs that are negatively charged and selectively permeate cations are termed cation exchange membranes (CEMs); IEMs that are positively charged and selectively permeate anions are termed anion exchange membranes (AEMs).

IEMs are employed in a wide range of ion transport applications, including electrodialysis desalination, the chloralkali process, water electrolyzers, fuel cells, etc. However, the charge-selectivity of IEMs (also referred to herein as a membrane's “permselectivity”) is severely diminished in high salinities (or, equivalently, high ionic strength environments). For example, current commercial ion-exchange membranes perform poorly in electrodialysis desalination of feeds above seawater salinity due to the deteriorated permselectivity. For this reason, IEMs are widely constrained to relatively low-salinity environments, e.g., desalination of brackish water.

### SUMMARY

Aspects of the present disclosure are directed to a method of making sulfonated polystyrene random copolymers (PS-r-SPS). In some embodiments, the method includes dissolving an amount of polystyrene in dichloromethane (DCM) to form a polymer mixture; boiling the polymer mixture; preparing a first reaction mixture including an amount of an acetic anhydride (AA) and an amount of sulfuric acid (H₂SO₄) in DCM; performing a first reaction of the first reaction mixture at about 0° C. for about 5 minutes, and subsequently at about room temperature for about 30 minutes; mixing the first reaction mixture with the polymer mixture to form a second reaction mixture; performing a second reaction of the second reaction mixture at about 39.6° C. for about 1 hour; adding the second reaction mixture to a water bath at a temperature above about 80° C.; collecting an acidic PS-r-SPS-H product from the water bath; contacting the acidic PS-r-SPS-H product with an excess amount of an alkali hydroxide; and collecting a neutralized PS-r-SPS-Y product, wherein Y is an alkali metal. In some embodiments, the alkali hydroxide includes NaOH. In some embodiments, the alkali hydroxide is provided in about 300% molar excess of the acidic PS-r-SPS-H product.

In some embodiments, the volumetric ratio of AA:H₂SO₄ in the first reaction mixture is about 3.6:10.8. In some embodiments, the sulfonation level of the neutralized PS-r-SPS-Y product is between about 0.07 and about 0.225. In some embodiments, the molar ratio of the amount of H₂SO₄ to concentration of polystyrene (H₂SO₄: polystyrene) is about 0.28.

Aspects of the present disclosure are directed to a method of making an ion-exchange membrane. In some embodiments, the method includes preparing a first reaction medium including a plurality of reactants. In some embodiments, the plurality of reactants include sulfuric acid (SA) and an acetic anhydride (AA). In some embodiments, the method includes reacting the first plurality of reactants at a first temperature for a first duration, and at a second temperature for a second duration, to form an acetyl sulfate product, and preparing a second reaction medium. In some embodiments, the second reaction medium includes at least a portion of the acetyl sulfate product and a concentration of PS. In some embodiments, the first temperature is about 0° C. In some embodiments, the first duration is about 5 minutes. In some embodiments, the second temperature is about room temperature. In some embodiments, the second duration is about 30 minutes. In some embodiments, the volumetric ratio of AA:SA in the first reaction medium is about 3.6:10.8. In some embodiments, the molar ratio of SA to PS monomers is between about 0.2 and about 0.30.

In some embodiments, the method includes reacting the second plurality of reactants at a third temperature and a third duration; transferring the second plurality of reactants to a water bath at a fourth temperature to form a PS-r-SPS-H product; converting at least a portion of the PS-r-SPS-H product to a PS-r-SPS-Y product, wherein Y is an alkali metal; and preparing a production solution. In some embodiments, converting at least a portion of the PS-r-SPS-H product to a PS-r-SPS-Y product includes contacting the PS-r-SPS-H product with excess alkali hydroxide. In some embodiments, the alkali hydroxide includes NaOH. In some embodiments, the third temperature is about 39.6° C. In some embodiments, the third duration is 1 hour. In some embodiments, the production solution includes at least a portion of the PS-r-SPS-Y product and an amount of dimethyl acetamide. In some embodiments, the method includes casting an ion-exchange membrane from the production solution. In some embodiments, the concentration of PS-r-SPS-Y product in the production solution is about 100 mg/mL. In some embodiments, the ion-exchange membrane has a permselectivity above about 0.99 for an NaCl solution.

Aspects of the present disclosure is directed to an electrodialysis system. In some embodiments, the system includes one or more polymer ion-exchange membranes including sulfonated polystyrene random copolymers, wherein the sulfonated polystyrene random copolymers include a random distribution of a first concentration of polystyrene repeat units and a second concentration sulfonated polystyrene repeat units. In some embodiments, the ratio of sulfonated polystyrene repeat units to polystyrene repeat units is between about 0.07 and about 0.225. In some embodiments, the polymer ion-exchange membrane includes:

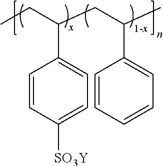

In some embodiments, Y is an alkali metal and x is between about 0.08 and about 0.17. In some embodiments, the polymer ion-exchange membrane is in fluid communication with a high-salinity feedstream, and the system further comprises an anode and a cathode in electrical communication with the polymer ion-exchange membrane and the high-salinity feedstream. In some embodiments, the polymer ion-exchange membrane has a permselectivity above about 0.99 for one or more charged components in the high-salinity feedstream.

In some embodiments, the polymer ion-exchange membrane is prepared by a method including preparing a first reaction medium including a first plurality of reactants. In some embodiments, the first plurality of reactants includes sulfuric acid (SA) and acetic anhydride (AA) at a volumetric ratio of AA:SA of about 3.6:10.8. In some embodiments, the method includes reacting the first plurality of reactants at about 0° C. for about 5 minutes, and at about room temperature for about 30 minutes to form an acetyl sulfate product and preparing a second reaction medium including a second plurality of reactants. In some embodiments, the second plurality of reactants includes the acetyl sulfate product and polystyrene (PS), wherein the molar ratio of SA to PS repeat units is between about 0.2 and about 0.30. In some embodiments, the method includes reacting the second plurality of reactants at about 39.6° C. for 1 hour; transferring the second plurality of reactants to a water bath at a temperature above about 80° C. to form a PS-r-SPS-H product; contacting the PS-r-SPS-H product with an excess concentration of an alkali hydroxide to form a PS-r-SPS-Y product, wherein Y is an alkali metal; preparing a production solution of PS-r-SPS-Y product and dimethyl acetamide; and casting an ion-exchange membrane from the production solution.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a chart of a method of making sulfonated polystyrene random copolymers (PS-r-SPS) according to some embodiments of the present disclosure;

FIG. 2 is a graph of proton nuclear magnetic resonance (¹H-NMR) spectra for PS-r-SPS-H polymers according to some embodiments of the present disclosure;

FIG. 3 is a chart of a method of making an ion-exchange membrane according to some embodiments of the present disclosure;

FIG. 4 is an image of a PS-r-SPS membrane according to some embodiments of the present disclosure;

FIGS. 5A and 5B are scanning electron microscopy (SEM) images of PS-r-SPS membranes according to some embodiments of the present disclosure;

FIG. 6 is a graph showing data related to the ion-exchange capacity of PS-r-SPS membranes according to some embodiments of the present disclosure;

FIG. 7 is a graph showing data related to the swelling degree of PS-r-SPS membranes according to some embodiments of the present disclosure;

FIG. 8 is a graph showing data related to the fixed charge density of PS-r-SPS membranes according to some embodiments of the present disclosure;

FIG. 9A is a graph showing data related to apparent and true permselectivity, a (circular symbols) and P (square symbols), respectively, as a function of fixed charge density for Selemion CMV membranes and PS-r-SPS membranes according to some embodiments of the present disclosure;

FIG. 9B is a graph showing data related to the electro-osmosis water transport number, t_{w}^{m}, of Na⁺ as a function of water volume fraction, f_{w}, for Selemion CMV membranes and PS-r-SPS membranes according to some embodiments of the present disclosure;

FIG. 9C is a graph showing data related to osmotic water permeability, A_{w,os}, as a function of water volume fraction, f_{w}, for Selemion CMV membranes and PS-r-SPS membranes according to some embodiments of the present disclosure;

FIG. 10 is a schematic representation of an electrodialysis system according to some embodiments of the present disclosure;

FIG. 11A is a graph showing data related to true permselectivity, P, and corresponding conductivity, κ, for PS-r-SPS membranes according to some embodiments of the present disclosure;

FIG. 11B is a graph showing data related to osmotic water permeability, A_{w,os}, and corresponding conductivity, κ, for PS-r-SPS membranes according to some embodiments of the present disclosure;

FIG. 12A is a schematic representation of a bench-scale electrodialysis system according to some embodiments of the present disclosure;

FIG. 12B is a schematic representation of ion transport in a bench-scale electrodialysis system according to some embodiments of the present disclosure;

FIGS. 13A-13B is a graph of data showing desalination performance of 4 M NaCl solution by PS-r-SPS membranes according to some embodiments of the present disclosure; and

FIG. 13B is a graph of data showing desalination performance of real brine PS-r-SPS membranes according to some embodiments of the present disclosure, where total dissolved solids, TDS, is shown as a function of operation time, t, for diluate solution (diamond symbols) and Concentrate 1 solution (square symbols).

### DETAILED DESCRIPTION

Some embodiments of the present disclosure are directed to polymer membranes and methods associated with those membranes. In some embodiments, the polymer membranes are ion-exchange membranes. In some embodiments, the ion-exchange membranes are cation exchange membranes. In some embodiments, the polymer membranes are incorporated into high-salinity electrodialysis desalination and/or other electromembrane systems and processes, as will be discussed in greater detail below.

In some embodiments, the polymer membranes include sulfonated polystyrene (SPS). In some embodiments, the SPS includes SPS polymer units, SPS oligomer units, SPS monomer units, or combinations thereof. In some embodiments, the SPS includes a polystyrene-based repeat unit functionalized at a phenyl group thereof with one or more sulfo groups. In some embodiments, the polymer membranes include polystyrene (PS). In some embodiments, the PS includes PS polymer units, PS oligomer units, PS monomer units, or combinations thereof. In some embodiments, the PS units include one or more non-sulfo functional groups. In some embodiments, the polymer membranes include copolymers, block copolymers, or combinations thereof, of PS and SPS. In some embodiments, the polymer membranes include sulfonated polystyrene random copolymers (PS-r-SPS). In some embodiments, the polymer membranes include a polymer structure according to the following Formula I:

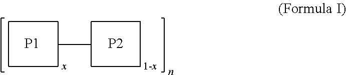

wherein P1 is an SPS consistent with the above-identified embodiments of the present disclosure, and P2 is a PS consistent with the above-identified embodiments of the present disclosure.

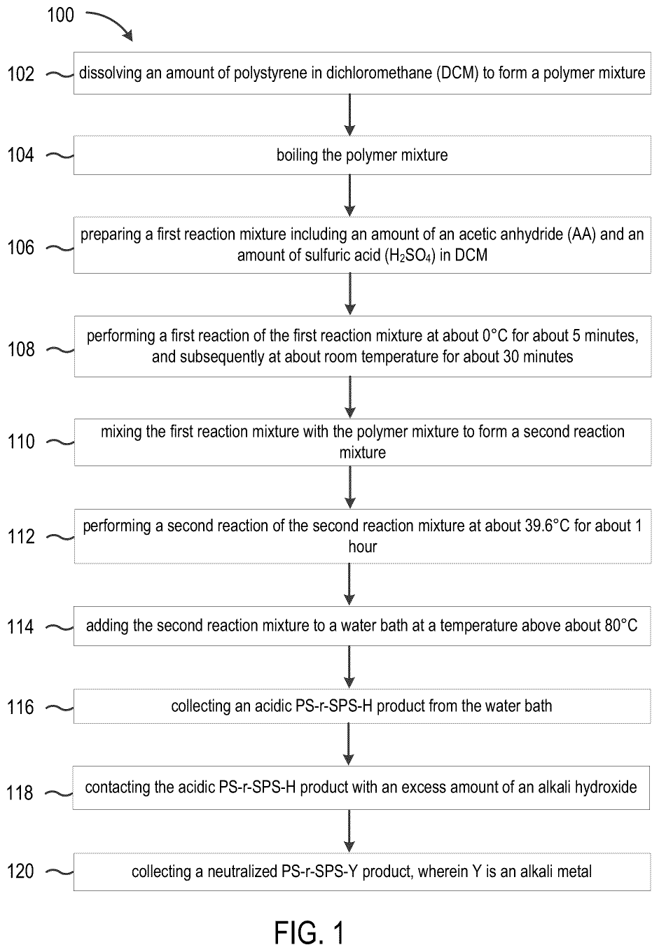

Referring now to FIG. 1, some embodiments of the present disclosure are directed to a method 100 of making PS-r-SPS. At 102, an amount of PS is dissolved in dichloromethane (DCM) to form a polymer mixture. In some embodiments, the concentration of PS in the polymer mixture is between about 20 mg/mL and about 30 mg/mL. In some embodiments, the concentration of PS in the polymer mixture is about 25 mg/mL. As discussed above, in some embodiments, the PS repeat units include PS polymer units, PS oligomer units, PS monomer units, or combinations thereof. At 104, the polymer mixture is heated. In some embodiments, at 104, the polymer mixture is brought to a boil.

At 106, a first reaction mixture is prepared. In some embodiments, the first reaction mixture includes an amount of an acetic anhydride (AA) and an amount of sulfuric acid (referred to herein, e.g., as “H₂SO₄” or “SA”. In some embodiments, the first reaction mixture includes DCM. In some embodiments, the amount of H₂SO₄ in the first mixture is controlled as the limiting reactant to thus control the evolution of reaction products, specifically the formation of acetyl sulfate. In some embodiments, the volumetric ratio of AA:H₂SO₄ in the first reaction mixture is about 3.6:10.8. At 108, a first reaction of the first reaction mixture is performed at a first temperature for a first duration. In some embodiments, the first reaction is performed 108 in a separate reaction vessel in contact with an ice bath to obtain the desired first temperature. In some embodiments, the first temperature is about at about 0° C. In some embodiments, the first duration is about 5 minutes. In some embodiments, the first reaction is then performed 108 at at least a second temperature for at least a second duration. In some embodiments, the second temperature is greater than the first temperature. In some embodiments, the first reaction is performed 108 at the second temperature by removing the separate reaction vessel from the ice bath and allowing the reaction vessel to warm in the ambient conditions. In some embodiments, the second temperature is about room temperature. In some embodiments, the second duration is about 30 minutes.

Still referring to FIG. 1, in some embodiments, at 110, the first reaction mixture is mixed with the polymer mixture to form a second reaction mixture. In some embodiments, it is the reaction products of the reaction performed at step 108 that are mixed with the polymer mixture at step 110. In some embodiments of step 110, at least a portion of the reaction products from step 108 are added to the polymer mixture. In some embodiments, mixing step 110 occurs after step 108, e.g., after the completion of the second duration. In some embodiments, the molar ratio of the amount of H₂SO₄, e.g., from step 106, to concentration of polystyrene repeat units (H₂SO₄:polystyrene), e.g., from steps 102 and/or 110, is between about 0.2 and 0.3. In some embodiments, the molar ratio H₂SO₄:polystyrene is about 0.28.

At 112, a second reaction of the second reaction mixture is performed. In some embodiments, the second reaction is performed 112 at a third temperature and for a third duration. In some embodiments, the third temperature is at or above the boiling point of the second reaction mixture. In some embodiments, the third temperature is at or above about 39.6° C., i.e., the boiling point of DCM. In some embodiments, the third duration is about 1 hour. At 114, the second reaction mixture is added to a water bath at a temperature again above the boiling point of the second reaction mixture. In some embodiments, the temperature of this water bath is about 80° C. The second reaction mixture is allowed to stop boiling, e.g., after about 30 minutes in some embodiments.

Still referring to FIG. 1, at 116, an acidic PS-r-SPS-H product is collected from the water bath. In some embodiments, at 118, the acidic PS-r-SPS-H product is contacted with an excess amount of an alkali hydroxide. In some embodiments, the alkali hydroxide is provided in about 300% molar excess of the acidic PS-r-SPS-H product. In some embodiments, the alkali hydroxide includes NaOH, LiOH, KOH, or combinations thereof. At 120, a neutralized PS-r-SPS-Y product is collected, wherein Y is an alkali metal, e.g., Na, Li, K, etc.

During the sulfonation reaction performed at step 112, at least a portion of the phenyl groups on the PS repeat units are functionalized with at least one sulfo group, resulting in the production of a random distribution but known quantity of SPS repeat units interspersed in a PS polymer chain, i.e., a random distribution of a first amount of polystyrene repeat units and a second amount of sulfonated polystyrene repeat units. The percent sulfonation or “sulfonation level” (SL) of the PS-r-SPS polymers, e.g., the acidic PS-r-SPS-H product, the neutralized PS-r-SPS-Y product, etc., and associated membranes composed of them, is the ratio of PS repeat units functionalized with sulfo groups to PS repeat units that are not functionalized with sulfo groups. In some embodiments, the sulfonation level of the PS-r-SPS polymers is between about 0.07 and about 0.225. In some embodiments, the sulfonation level of the PS-r-SPS polymers is between about 0.08 and about 0.17. In some embodiments, the sulfonation level of the PS-r-SPS polymers is about 0.101.

In an exemplary embodiment, polystyrene was dissolved in DCM (25 mg/mL) and boiled under reflux in a sealed three-neck flask. DCM and acetic anhydride were added to a separate 7 mL vial, stirred, and placed in an ice bath. H₂SO₄, used as a limiting reactant to control the formation of acetal sulfate, was added to the vial and allowed to react for 5 min at 0° C. The vial was then removed from the bath and allowed to stir for 30 minutes at room temperature. The volumetric ratio of AA and H₂SO₄ was about 3.6:10.8.

In this exemplary embodiment, the ratio of H₂SO₄ to PS repeat unit was varied to control the sulfonation (e.g., H₂SO₄:PS=0.28 for 10.1 sulfonation level) of the PS-r-SPS polymers. In some embodiments, after 30 minutes, the contents of the vial were added to the flask containing the PS/DCM solution by removing and replacing a glass septum. The sulfonation reaction was allowed to proceed in boiling DCM (39.6° C.) for 1 hour.

Immediately following the sulfonation reaction, the reaction solution was slowly added to a water bath at 80° C. and vigorously stirred using a polytetrafluoroethylene (PTFE) paddle mixer. After the solution stopped boiling (about 30 min), the PS-r-SPS-H product was collected using qualitative filtration and washed with 4 L deionized water. The product was then dissolved in acetone and allowed to evaporate at room temperature.

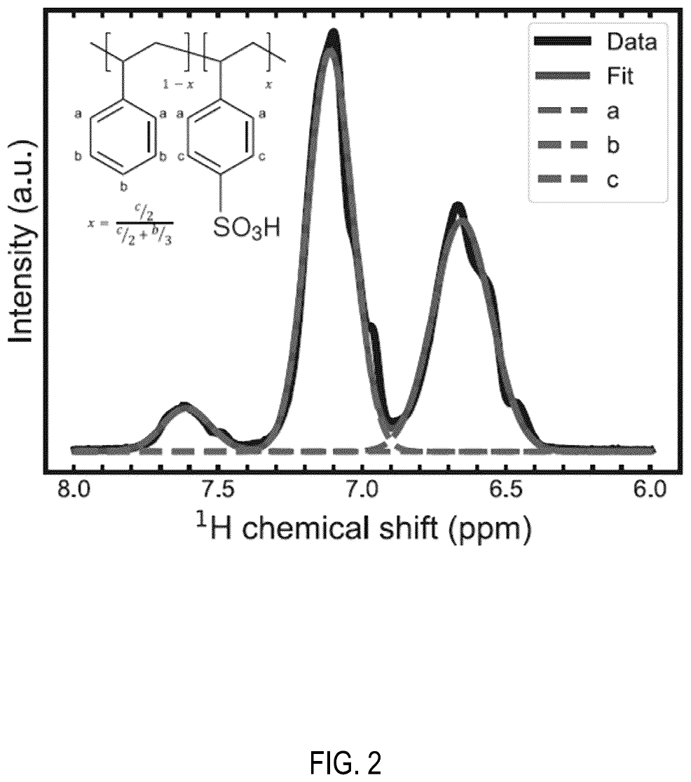

Referring now to FIG. 2, a small sample of the PS-r-SPS-H product was redissolved in acetone-D₆ for proton nuclear magnetic resonance (¹H-NMR) characterization. The SL was determined by fitting three Gaussians to three peaks in the region between 6.0 and 8.0 ppm after linear baseline subtraction. The SL was then calculated based on the analytical areas under the Gaussian curves.

To measure the composition of exemplary ion-exchange membranes consistent with embodiments of the present disclosure, the copolymer in the acidic form was utilized; neutralized copolymers are insoluble in deuterated acetone. To prepare the neutralized salts, the PS-r-SPS-H polymer was dissolved in THF (25 mg/mL). An equal volume of methanol was then added. Based on the SL calculated from 1H-NMR, IM aqueous alkali hydroxide solution, e.g., NaOH, was added in 300% excess to achieve conversion from the acidic PS-r-SPS-H form to the neutral salt form. The solutions were then mixed to accomplish the neutralization in the liquid phase. The PS-r-SPS-Na product was then collected by boiling the solutions, dialyzed against DI water for at least 72 hours to remove excess salt, and dried for at least 12 hours at 110° C. under vacuum.

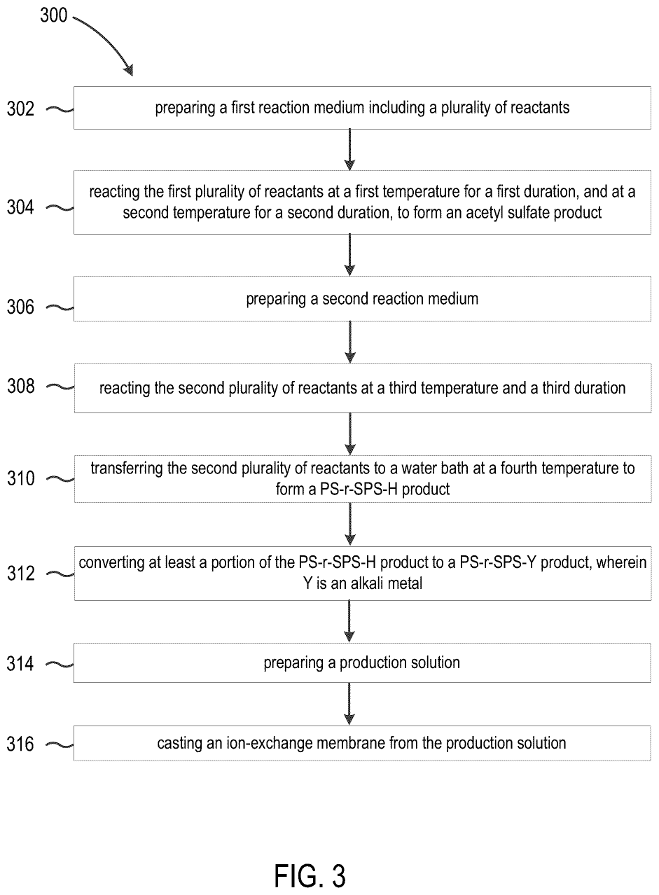

Referring now to FIG. 3, some embodiments of the present disclosure are directed to a method 300 of making an ion-exchange membrane. In some embodiments, the ion-exchange membrane is a cation exchange membrane. At 302, a first reaction medium including a plurality of reactants is prepared. As discussed above, in some embodiments, the plurality of reactants include SA and an AA. In some embodiments, the volumetric ratio of AA:SA in the first reaction medium is about 3.6:10.8. At 304, the first plurality of reactants is reacted at a first temperature for a first duration, and then subsequently at a second temperature for a second duration. As discussed above, in some embodiments, the reaction 304 is performed in a separate reaction vessel in contact with an ice bath to obtain the desired first temperature. In some embodiments, the first temperature is about 0° C. . . . In some embodiments, the first duration is about 5 minutes. In some embodiments, the second temperature is greater than the first temperature. In some embodiments, reaction 304 is performed at the second temperature by removing the separate reaction vessel from the ice bath and allowing the reaction vessel to warm in the ambient conditions. In some embodiments, the second temperature is about room temperature. In some embodiments, the second duration is about 30 minutes. In some embodiments, reaction 304 produces an acetyl sulfate product.

At 306, a second reaction medium is prepared. In some embodiments, the second reaction medium includes a concentration of acetyl sulfate and a concentration of PS. In some embodiments, at least a portion of the concentration of acetyl sulfate includes acetyl sulfate product from reaction 304. In some embodiments (not pictured), step 306 is performed without performing steps 302 and 304, i.e., method 300 begins with step 306.

In some embodiments, the concentration of PS is formed, as discussed above, by dissolving an amount of PS in DCM to form a polymer mixture. In some embodiments, the concentration of PS in the polymer mixture is between about 20 mg/mL and about 30 mg/mL. In some embodiments, the concentration of PS in the polymer mixture is about 25 mg/mL. As discussed above, in some embodiments, the concentration of PS includes PS repeat units including PS polymer units, PS oligomer units, PS monomer units, or combinations thereof. In some embodiments, the molar ratio of the amount of H₂SO₄, e.g., from step 302, to concentration of polystyrene repeat units (H₂SO₄:polystyrene), e.g., from step 306, is between about 0.2 and 0.3. In some embodiments, the molar ratio H₂SO₄:polystyrene is about 0.28.

Still referring to FIG. 3, at 308, the second plurality of reactants is reacted at a third temperature and a third duration. As discussed above, in some embodiments, the third temperature is at or above the boiling point of the second reaction mixture. In some embodiments, the third temperature is at or above about 39.6° C., i.e., the boiling point of DCM. In some embodiments, the third duration is about 1 hour. At 310, at least a portion of the second plurality of reactants is transferred to a water bath at a fourth temperature to form a PS-r-SPS-H product. Again, as discussed above, in some embodiments, the fourth temperature is above the boiling point of, e.g., DCM. In some embodiments, the temperature of the water bath at step 310 is about 80° C. At 312, at least a portion of the PS-r-SPS-H product is converted to a PS-r-SPS-Y product, wherein Y is an alkali metal. In some embodiments, conversion 312 includes contacting PS-r-SPS-H product with an excess amount of an alkali hydroxide. In some embodiments, the alkali hydroxide is provided in about 300% molar excess of the acidic PS-r-SPS-H product. In some embodiments, the alkali hydroxide includes NaOH, LiOH, KOH, or combinations thereof.

At 314, a production solution is prepared. In some embodiments, the production solution includes at least a portion of the PS-r-SPS-Y product, e.g., from step 312, and an amount of dimethyl acetamide (DMAc). In some embodiments, the concentration of PS-r-SPS-Y product in the production solution is about 100 mg/mL. At 316, an ion-exchange membrane from the production solution is cast. DMAc is beneficial for use in steps 314 and 316 due to its high solubility and low volatility. Further, DMAc is a high boiling solvent (T_{b}=165° C.) that plasticizes the membrane to varying extents in the fabrication procedure. Residual solvent present after the initial casting, e.g., at step 316, allows the membranes to be removed from a casting mold and punched to a desired size. In some embodiments, the sulfonation level of the ion-exchange membrane is between about 0.07 and about 0.225. In some embodiments, the sulfonation level of the ion-exchange membrane is between about 0.08 and about 0.17. In some embodiments, the sulfonation level of the ion-exchange membrane is about 0.101. In some embodiments, the ion-exchange membrane has a permselectivity above about 0.99 for a high-salinity feedstream, e.g., brines, industrial effluent streams, etc., or combinations thereof. In some embodiments, the ion-exchange membrane has a permselectivity above about 0.99 for an NaCl solution.

In an exemplary embodiment, concentrated solutions (100 mg/mL) of neutralized PS-r-SPS-Na were prepared in DMAc. The volume of solution to make a 250 μm thick membrane was then pipetted into a PTFE mold (D=¾″, z=¼″) and allowed to slowly evaporate at 35° C. for at least 6 hours. The membranes were then carefully removed and punched to the desired diameter (16 mm). The membranes were placed between two pieces of 3M Electroplater's tape (ID=12 mm) and dried at 110° C. for 12 hours at −15 inHg to remove most but not all of the DMAc solvent. Perforated Kapton films were used to prevent the formation of small bubbles and to keep membranes flat during drying. The membranes were then placed in a IM aqueous solution of NaCl for further characterization. Residual solvent after drying at 110° C. allowed the membranes to absorb a controlled amount of water from an aqueous solution. Without wishing to be bound by theory, the equilibrium water content in the membrane dictates membrane conductivity and selectivity.

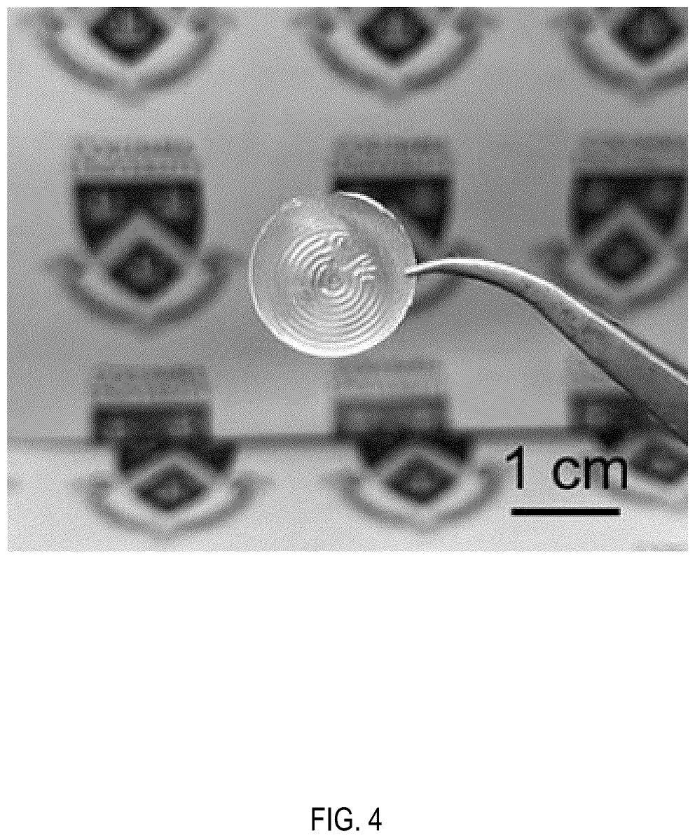

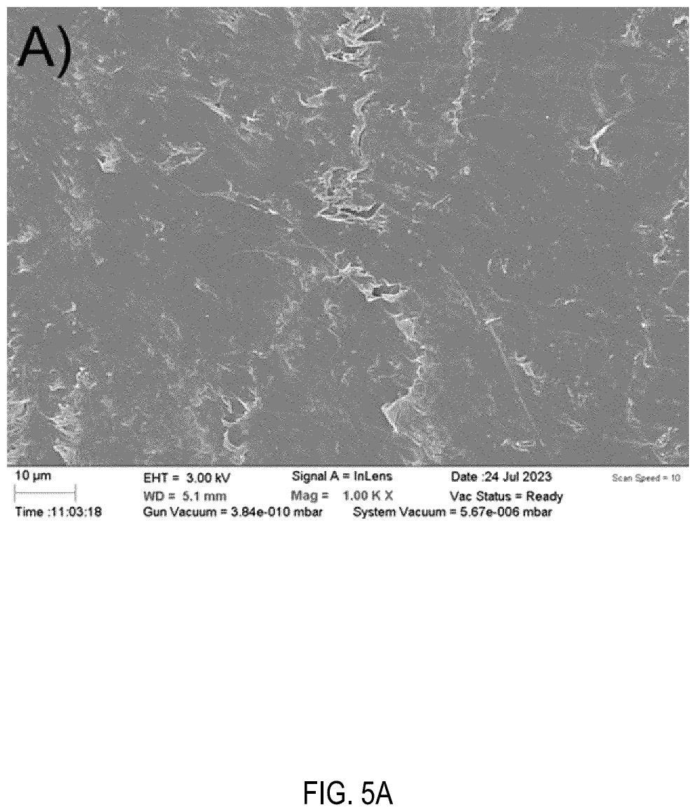

Referring now to FIG. 4 and FIGS. 5A-5B, in a further exemplary embodiment, a PS-r-SPS-Na membrane was prepared for additional characterization. Wrinkles on the membrane surface shown in FIG. 4 were due to a surface pattern of the PTFE mold used for membrane fabrication. Scanning electron microscope (SEM) images of planar (FIG. 5A, at 1,000× magnification) and the cross-sectional (FIG. 5B at 205× magnification) views of the exemplary membrane are provided. The sulfonation level of the exemplary membrane was 0.15.

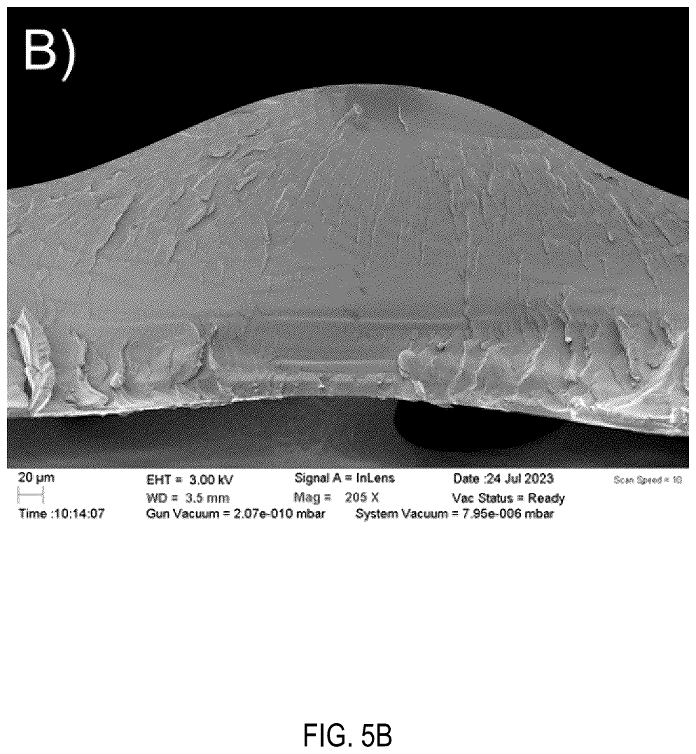

Referring now to FIG. 6, the ion-exchange capacity (IEC) for exemplary membranes consistent with embodiments of the present disclosure was measured as a function of sulfonation level. The IEC was a measure of the number of fixed charges per unit dry mass of the membrane. IEC almost linearly increased with SL, as there were more units in the copolymer carrying charged functional groups. Furthermore, IEC measured by acid-based titration was corroborated by the results determined from 1H-NMR characterization (denoted by the dashed line in the graph), confirming precise control over functionalization levels of the membranes of the present disclosure.

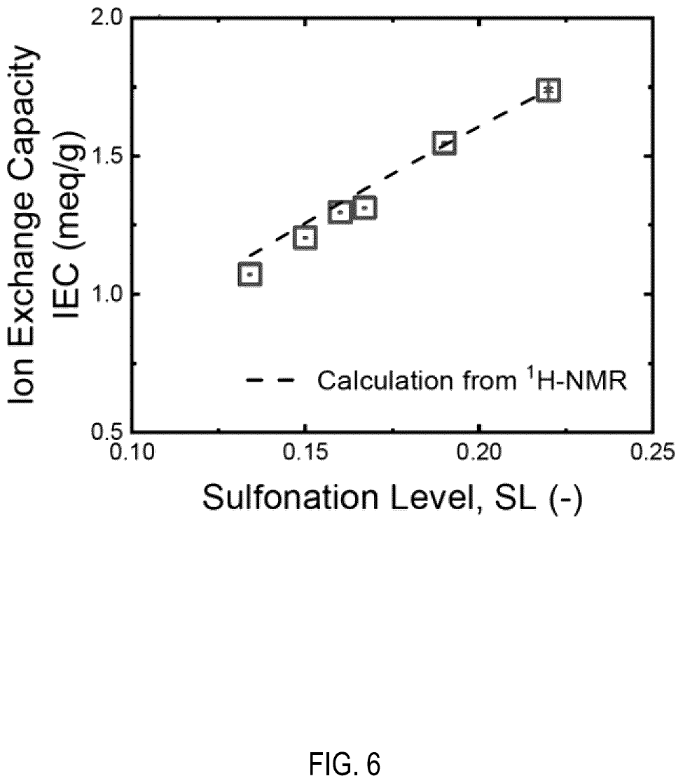

Referring now to FIG. 7, the swelling degree of exemplary membranes consistent with embodiments of the present disclosure was measured as well. The swelling degree was the mass of water sorbed by unit mass of dry membrane. Swelling degree of the exemplary membranes was also shown to increase with growing SL. Without wishing to be bound by theory, this trend can be attributed to the augmented presence of hydrophilic charged functional groups in the membrane matrix.

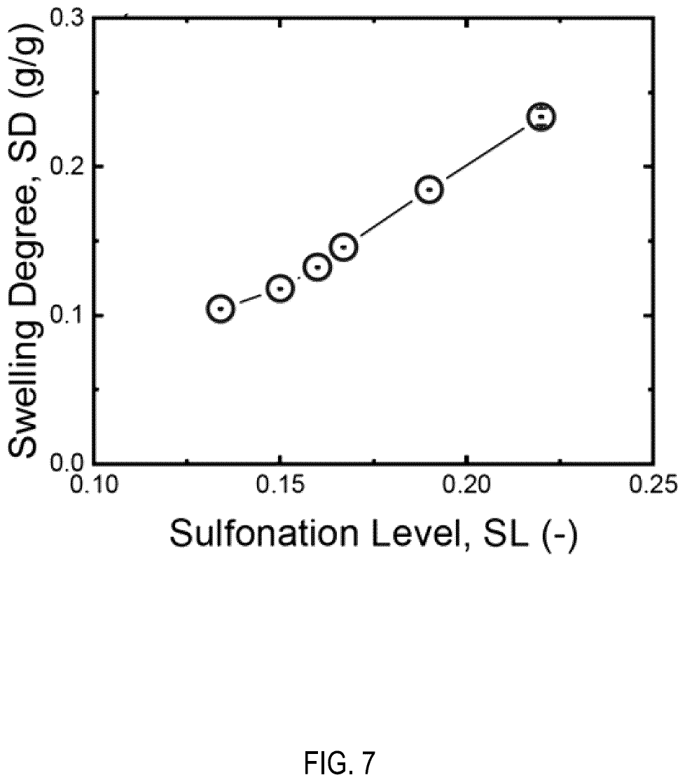

Referring now to FIG. 8, the fixed charge density (c_{fix}) of exemplary membranes consistent with embodiments of the present disclosure was measured. C_{fix} was the number of fixed charges per unit water volume in the membrane, and was shown to decrease with increasing SL. This suggests that while IEC escalates with SL, water content can grow faster, leading to the dilution of fixed charges in the membrane matrix.

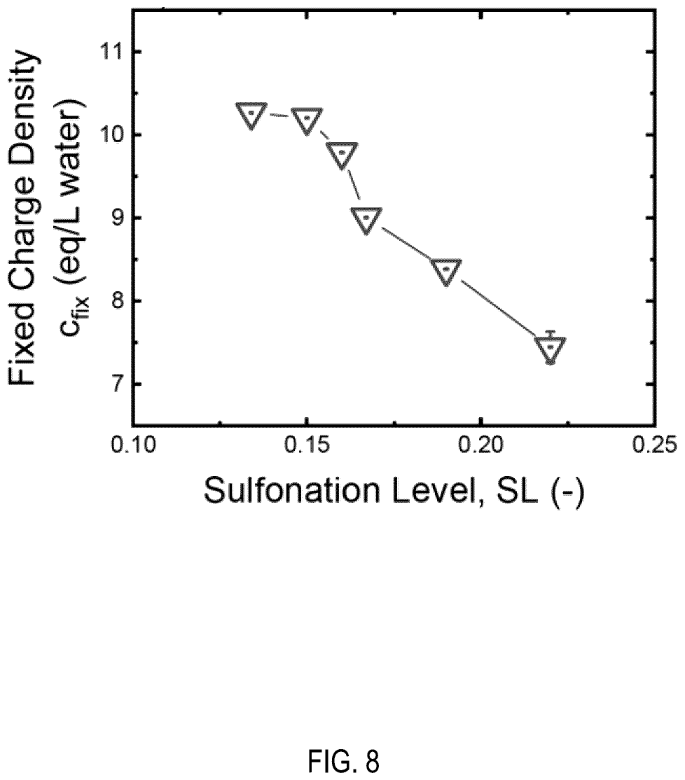

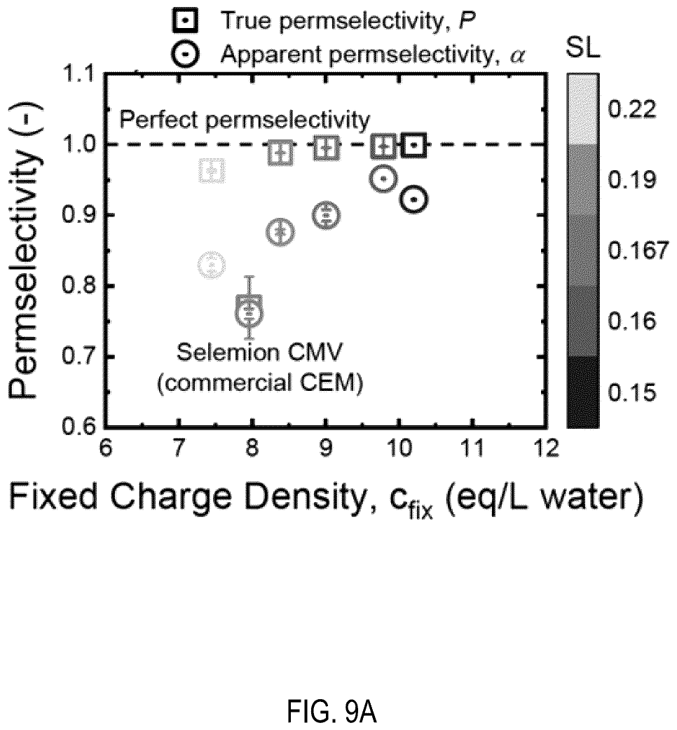

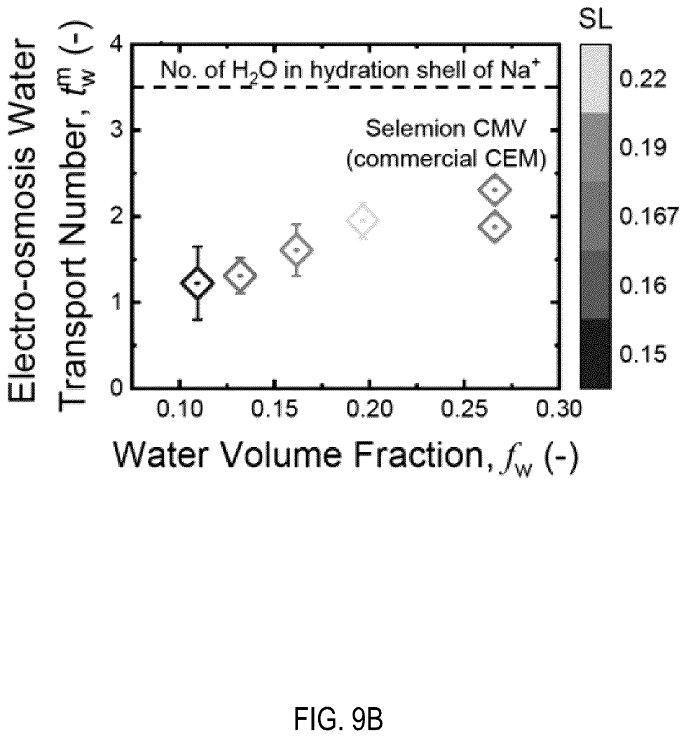

Referring now to FIGS. 9A-9C, ion and water transport properties of exemplary PS-r-SPS-Na membranes were analyzed. Bars to the right of plots denote SL of the exemplary PS-r-SPS-Na membranes. The data of a commercial CEM, Selemion CMV, is shown by gray symbols of the same shapes for comparison, while in FIG. 9B the top and bottom gray diamond symbols indicate the upper and lower limit of estimation for the commercial CEM.

Referring specifically to FIG. 9A, membrane permselectivity was determined by two IEM characterization techniques, termed the “static” method and the “dynamic” method (also known as the “electrodialysis” or “ED” method), giving rise to apparent (a), and true (P) permselectivity, respectively. The dashed horizontal line indicates the “perfect” permselectivity. In the static method, membranes consistent with embodiments of the present disclosure separated 4.0 and 0.8 M NaCl solutions and the electrical potential difference across membrane was used to determine apparent permselectivity. The a of exemplary PS-r-SPS-Na membranes increased from 0.83 to 0.95 when c_{fix} rose from 7.4 to 10 eq/L (circular symbols in FIG. 9A). They were much higher than the 0.76 for the commercial Selemion CMV membrane.

In the ED method, membranes consistent with embodiments of the present disclosure were challenged in 4.0 M NaCl solution and the transport of co-ion, i.e., Cl⁻, through the membrane was utilized to calculate P. The exemplary PS-r-SPS-Na membranes showed P from 0.96 to >0.99 as the increase of c_{fix} which significantly surpassed the 0.77 of Selemion CMV (square symbols in FIG. 9A). These results underscore the efficacy of membranes consistent with embodiments of the present disclosure in facilitating high current efficiency in hypersaline ED desalination. Without wishing to be bound by theory, the difference between true and apparent permselectivity can be attributed to electro-osmosis, wherein migrating ions drag along nearby water molecules in the dynamic ED process used for P measurement.

Referring now to FIG. 9B, the water transport number, t_{w}^{m}, was characterized. t_{w}^{m} represents the number of water molecules transported alongside one migrating ion, and was measured through the Hittorf method with 4 M NaNO₃ solution. The black dashed horizontal line represents the number of water molecules in the hydration shell of Na⁺. When the water volume fraction, f_{w}, in the exemplary PS-r-SPS-Na membranes decreased from 0.20 to 0.11, t_{w}^{m} was reduced from 1.9 to 1.2. This is much less than the estimated range of 1.9 to 2.3 for the commercial Selemion CMV. Thus, electro-osmotic water transport in ED desalination is more effectively suppressed utilizing membranes consistent with embodiments of the present disclosure.

Additionally, without wishing to be bound by theory, Na⁺ experiences partial dehydration when migrating through membranes consistent with embodiments of the present disclosure, as evidenced by the water transport numbers being lower than the number of water molecules in the solvation shell of the ion. This can indicate that the water-deficient membrane matrix compels ions to partially lose hydration waters, with the degree of dehydration increasing as the membrane becomes more water-deficient.

Referring now to FIG. 9C, water permeability of exemplary PS-r-SPS-Na membranes was characterized in a diffusion cell in which the membrane separated 4 M NaCl solution and pure water. The osmotic water permeability, A_{w,os}, of membranes consistent with embodiments of the present disclosure significantly decreased with lower f_{w}, and could reach levels much lower than the Selemion CMV, indicating an ability to offer largely suppressed osmotic water transport in ED desalination.

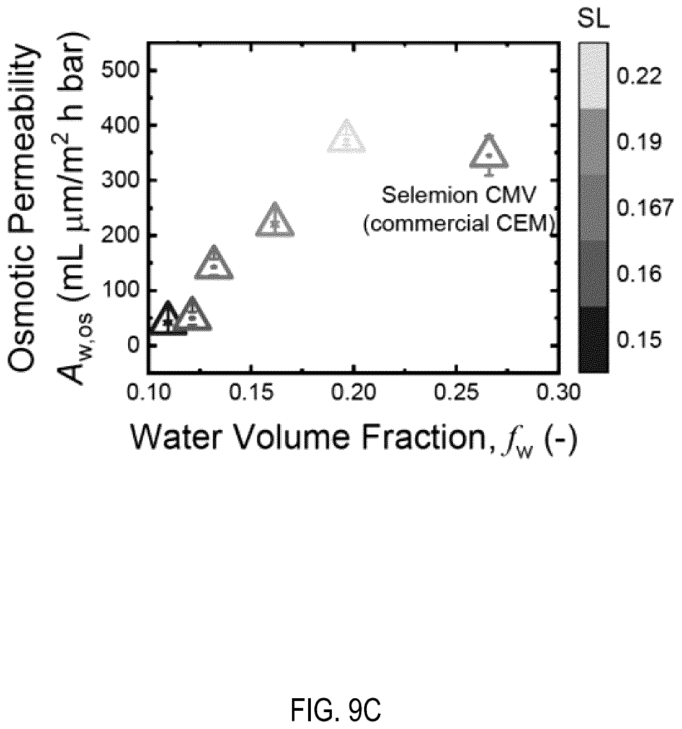

Referring now to FIG. 10, some embodiments of the present disclosure are directed to a system incorporating the PS-r-SPS polymers and membranes made therefrom consistent with the embodiments of the present disclosure described above. In an exemplary embodiment, the present disclosure is directed to an electrodialysis system 1000. In some embodiments, system 1000 includes one or more polymer ion-exchange membranes 1002. In some embodiments, at least one membrane 1002A is a cation exchange membrane that is structurally and compositionally consistent with those made from method 300 above, or made with the polymers made from method 100 above. In some embodiments, membrane 1002A include PS-r-SPS. In some embodiments, the sulfonation level of ion-exchange membrane 1002A is between about 0.07 and about 0.225. In some embodiments, the sulfonation level of ion-exchange membrane 1002A is between about 0.08 and about 0.17. In some embodiments, the sulfonation level of ion-exchange membrane 1002A is about 0.101.

In some embodiments, ion-exchange membrane 1002A includes the following polymer structure:

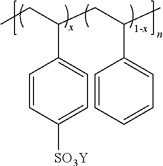

In some embodiments, Y is an alkali metal. In some embodiments, x is between about 0.07 and about 0.225. In some embodiments, x is between about 0.08 and about 0.17. In some embodiments, x is about 0.101.

Still referring to FIG. 10, in some embodiments, polymer ion-exchange membrane 1002A is in fluid communication with a high-salinity feedstream 1004. In some embodiments, high-salinity feedstream 1004 includes one or more brines, industrial effluent streams, etc., or combinations thereof. In some embodiments, system 1000 includes at least one pair of electrodes, e.g., an anode 1006 and a cathode 1008, in electrical communication with polymer ion-exchange membrane 1002A and high-salinity feedstream 1004. In some embodiments, polymer ion-exchange membrane 1002A has a permselectivity above about 0.99 for one or more charged components in high-salinity feedstream 1004. In some embodiments, polymer ion-exchange membrane 1002A has a permselectivity above about 0.99 for an NaCl solution.

As discussed above, in some embodiments, polymer ion-exchange membrane 1002A is prepared by a method consistent with method 300 above, or made with the polymers made from method 100 above. In some embodiments, polymer ion-exchange membrane 1002A is prepared by preparing a first reaction medium including a first plurality of reactants. In some embodiments, the first plurality of reactants include SA and an AA at a volumetric ratio of AA:SA of about 3.6:10.8. In some embodiments, the first plurality of reactants is reacted at about 0° C. for about 5 minutes, and subsequently at about room temperature for about 30 minutes to form an acetyl sulfate product. In some embodiments, a second reaction medium including a second plurality of reactants is prepared. In some embodiments, the second plurality of reactants include the acetyl sulfate product and PS. In some embodiments, the molar ratio of SA to PS repeat units is between about 0.2 and about 0.30. In some embodiments, the second plurality of reactants was reacted at about 39.6° C. for 1 hour. In some embodiments, the second plurality of reactants is transferred to a water bath at a temperature above about 80° C. to form a PS-r-SPS-H product. In some embodiments, the PS-r-SPS-H product is contacted with an excess concentration of an alkali hydroxide to form a PS-r-SPS-Y product, wherein Y is an alkali metal. In some embodiments, a production solution of PS-r-SPS-Y product and DMAc is prepared. In some embodiments, an ion-exchange membrane is cast from the production solution.

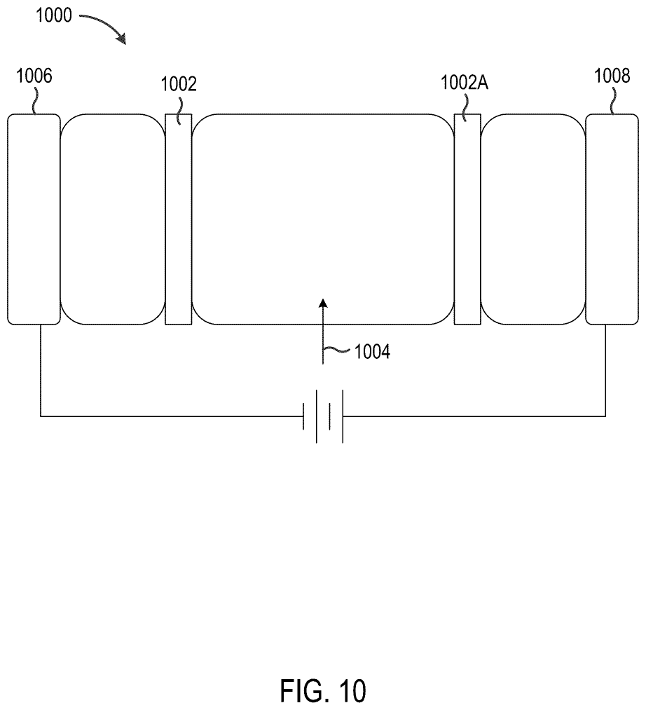

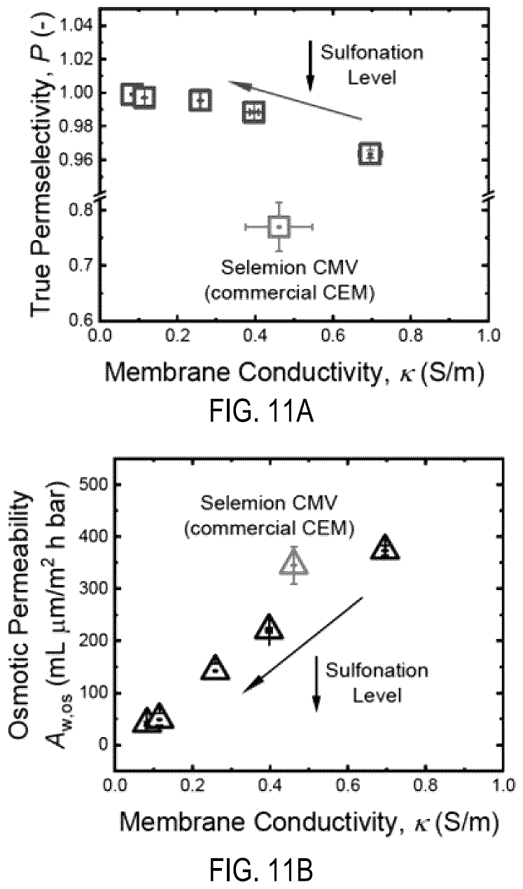

Referring now to FIGS. 11A-11B, conductivity of PS-r-SPSNa membranes consistent with embodiments of the present disclosure was measured in 1 M NaCl solution using a two-chamber and four-electrode cell system with the direct current chronopotentiometry method employed. The data of a Selemion CMV is shown for comparison. In FIG. 11A, with the enhancement of true permselectivity, P, membrane conductivity, K, was sacrificed. Additionally, the exemplary PS-r-SPS-Na membranes can have both higher permselectivity and conductivity than Selemion CMV (the tradeoff trend of PS-r-SPS-Na membranes is to the top right of the commercial CEM). In FIG. 11B, the reducing water permeability, A_{w,os}, of fabricated membranes also incurs the deterioration of membrane conductivity. But the exemplary PS-r-SPS-Na membranes exhibited lower osmotic water permeability than the commercial counterparts when the membrane conductivity is close (or better membrane conductivity when the water permeability is the same).

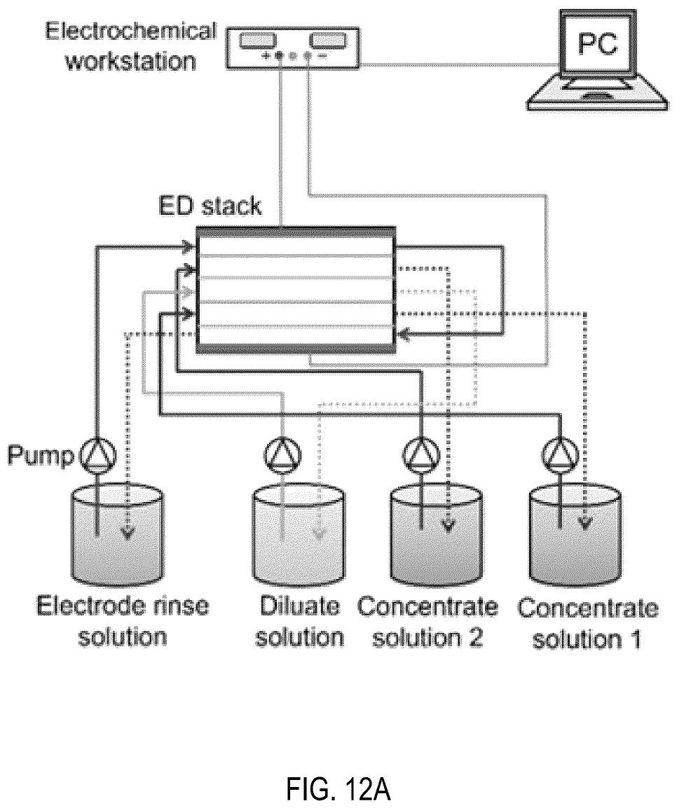

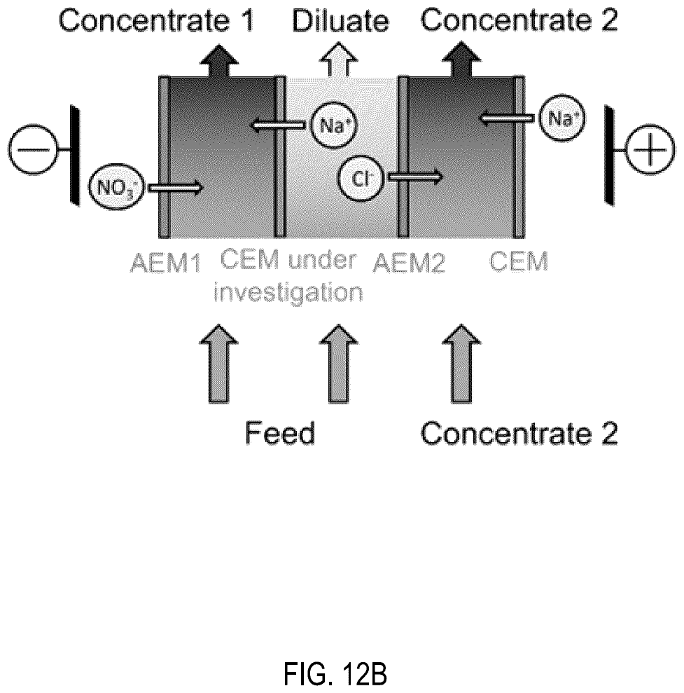

Referring now to FIG. 12A, high-salinity ED desalination was conducted in a bench-scale ED system to compare the performance of using PS-r-SPS-Na membranes consistent with embodiments of the present disclosure and the commercial Selemion CMV membranes. A schematic representation of ion transport in the exemplary ED stack is portrayed in FIG. 12B.

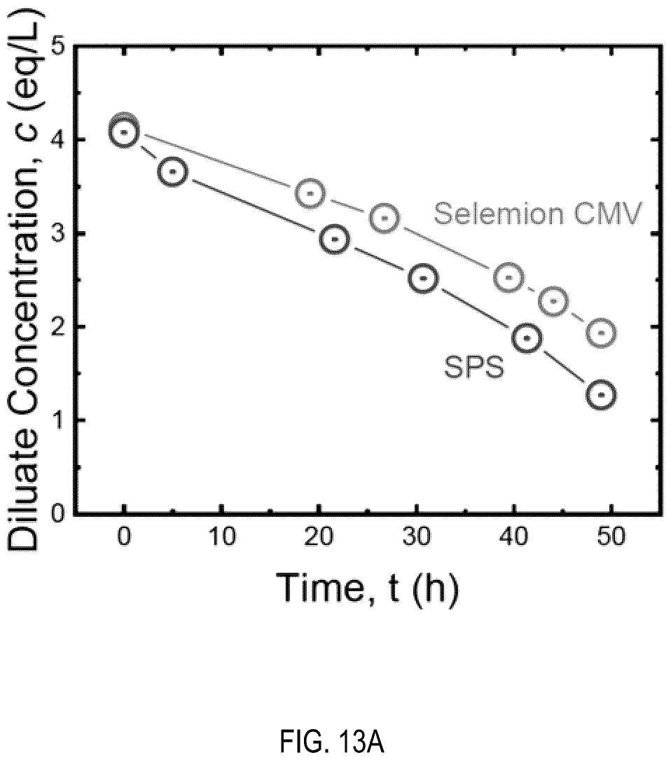

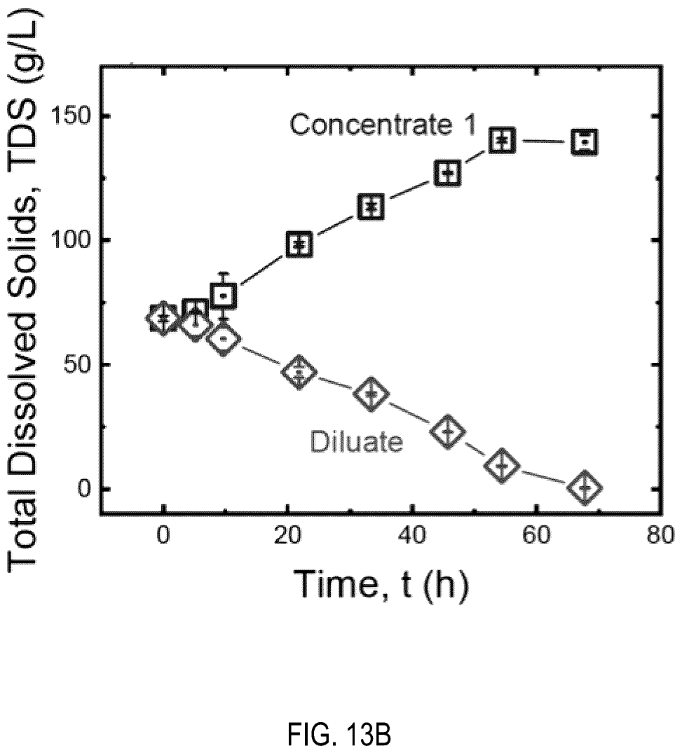

Referring now to FIG. 13A, comparison of desalination performance of 4 M NaCl solution by the exemplary PS-r-SPS-Na membranes with SL=0.15 and commercial Selemion CMV is shown. Salt concentration in diluate solution (total cation concentration), c, is plotted as a function of operation time, t, with symbols denoting PS-r-SPS-Na membranes consistent with embodiments of the present disclosure and Selemion CMV, respectively. When treating the feed of 4 M NaCl solution, the exemplary PS-r-SPS-Na membranes demonstrated notably faster desalination, so that the salt rejection, SR, improved from 0.53 for Selemion CMV test to 0.69 for the PS-r-SPS membrane (Table 1). The exemplary PS-r-SPS-Na membranes also improved current efficiency, CE, over the commercial membrane, which was 0.95 and 0.89, respectively. Finally, the PS-r-SPS-Na exemplary membranes showed a water recovery, WR, of 0.27, which is higher than 0.25 of the Selemion CMV test (Table 1).

TABLE 1
Comparison of SR, WR, and CE between ED using PS-
r-SPS-Na membrane with SL = 0.15 and commercial
Selemion CMV to desalinate 4M NaCl solution.

| | Salt Rejection | Water Recovery | Current Efficiency |
|---|---|---|---|
| Membrane | (SR) (—) | (WR) (—) | (CE) (—) |
| PS-r-SPS-Na | 0.69 | 0.27 | 0.95 |
| Selemion CMV | 0.53 | 0.25 | 0.89 |

Referring now to FIG. 13B, PS-r-SPS-Na membranes consistent with embodiments of the present disclosure with SL=0.185 were used to treat real brine from a seawater desalination plant (Tampa Bay Water, Gibsonton, FL). When used to desalinate the real brine, there was near-complete removal of total dissolved solids, TDS, in the diluate stream, while the salinity in Concentrate 1 stream almost doubled, showing the capability of the membranes of the present disclosure in effectively desalinating practical hypersaline brines within the ED process.

Systems and methods of the present disclosure are advantageous to carefully control a random copolymer composition in an ion-exchange membrane. These facile methods fabricate polystyrene membranes sulfonated to predetermined degrees, exhibiting high charge densities and low hydration degrees. The predetermined levels of sulfonation are achieved, at least in part, via control over reaction times, reaction temperatures, and sulfuric acid loading in the reaction mediums.

These membranes maintain high permselectivity under various high solution concentrations, thus realizing high-salinity electrodialysis desalination and other electromembrane processes where current IEMs typically operate very poorly. Current IEMs have low charge-selectivity in high-salinity environments and are hence confined to relatively low salinities. The membranes of the present disclosure can expand the operating range of IEMs and enable numerous additional applications, including high-salinity electrodialysis desalination and other electromembrane processes. Other potential applications of the systems and methods of the present disclosure can include improved efficiency of the chloralkali process, water electrolyzers, fuel cells, etc.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A method of making sulfonated polystyrene random copolymers (PS-r-SPS), comprising:
dissolving an amount of polystyrene in dichloromethane (DCM) to form a polymer mixture;
boiling the polymer mixture;
preparing a first reaction mixture including an amount of an acetic anhydride (AA) and an amount of sulfuric acid (H₂SO₄) in DCM;
performing a first reaction of the first reaction mixture at about 0° C. for about 5 minutes, and subsequently at about room temperature for about 30 minutes;
mixing the first reaction mixture with the polymer mixture to form a second reaction mixture;
performing a second reaction of the second reaction mixture at about 39.6° C. for about 1 hour;
adding the second reaction mixture to a water bath at a temperature above about 80° C.;
collecting an acidic PS-r-SPS-H product from the water bath;
contacting the acidic PS-r-SPS-H product with an excess amount of an alkali hydroxide; and
collecting a neutralized PS-r-SPS-Y product, wherein Y is an alkali metal.

2. The method according to claim 1, wherein the volumetric ratio of AA:H₂SO₄ in the first reaction mixture is about 3.6:10.8.

3. The method according to claim 1, wherein the sulfonation level of the neutralized PS-r-SPS-Y product is between about 0.07 and about 0.225.

4. The method according to claim 1, wherein the molar ratio of the amount of H₂SO₄ to concentration of polystyrene (H₂SO₄:polystyrene) is about 0.28.

5. The method according to claim 1, wherein the alkali hydroxide includes NaOH.

6. The method according to claim 5, wherein the alkali hydroxide is provided in about 300% molar excess of the acidic PS-r-SPS-H product.

7. A method of making an ion-exchange membrane, comprising:
preparing a first reaction medium including a plurality of reactants, the plurality of reactants including:
sulfuric acid (SA); and
an acetic anhydride (AA),
reacting the first plurality of reactants at a first temperature for a first duration, and at a second temperature for a second duration, to form an acetyl sulfate product;
preparing a second reaction medium, the second reaction medium including:
at least a portion of the acetyl sulfate product; and
a concentration of polystyrene (PS);
reacting the second plurality of reactants at a third temperature and a third duration;
transferring the second plurality of reactants to a water bath at a fourth temperature to form a PS-r-SPS-H product;
converting at least a portion of the PS-r-SPS-H product to a PS-r-SPS-Y product, wherein Y is an alkali metal;
preparing a production solution, the production solution including:
at least a portion of the PS-r-SPS-Y product; and
an amount of dimethyl acetamide; and
casting an ion-exchange membrane from the production solution,
wherein the sulfonation level of the ion-exchange membrane is between about 0.07 and about 0.225.

8. The method according to claim 7, wherein:
the first temperature is about 0° C.;
the first duration is about 5 minutes;
the second temperature is about room temperature; and
the second duration is about 30 minutes.

9. The method according to claim 7, wherein the molar ratio of SA to PS monomers is between about 0.2 and about 0.30.

10. The method according to claim 7, wherein:
the third temperature is about 39.6° C.; and
the third duration is 1 hour.

11. The method according to claim 7, wherein the volumetric ratio of AA:SA in the first reaction medium is about 3.6:10.8.

12. The method according to claim 7, wherein converting at least a portion of the PS-r-SPS-H product to a PS-r-SPS-Y product includes:
contacting the PS-r-SPS-H product with excess alkali hydroxide.

13. The method according to claim 12, wherein the alkali hydroxide includes NaOH.

14. The method according to claim 7, wherein the concentration of PS-r-SPS-Y product in the production solution is about 100 mg/mL.

15. The method according to claim 7, wherein the ion-exchange membrane has a permselectivity above about 0.99 for an NaCl solution.

16. An electrodialysis system, the system comprising:
one or more polymer ion-exchange membranes including sulfonated polystyrene random copolymers, wherein the sulfonated polystyrene random copolymers include a random distribution of a first concentration of polystyrene repeat units and a second concentration sulfonated polystyrene repeat units,
wherein the ratio of sulfonated polystyrene repeat units to polystyrene repeat units is between about 0.07 and about 0.225.

17. The electrodialysis system according to claim 16, wherein the polymer ion-exchange membrane includes: 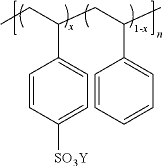
wherein Y is an alkali metal and x is between about 0.08 and about 0.17.

18. The electrodialysis system according to claim 16, wherein the polymer ion-exchange membrane is in fluid communication with a high-salinity feedstream, and the system further comprises an anode and a cathode in electrical communication with the polymer ion-exchange membrane and the high-salinity feedstream.

19. The electrodialysis system according to claim 16, wherein the polymer ion-exchange membrane has a permselectivity above about 0.99 for one or more charged components in the high-salinity feedstream.

20. The electrodialysis system according to claim 16, wherein the polymer ion-exchange membrane is prepared by a method including:
preparing a first reaction medium including a first plurality of reactants, the first plurality of reactants including:
sulfuric acid (SA) and acetic anhydride (AA) at a volumetric ratio of AA:SA of about 3.6:10.8,
reacting the first plurality of reactants at about 0° C. for about 5 minutes, and at about room temperature for about 30 minutes to form an acetyl sulfate product;
preparing a second reaction medium including a second plurality of reactants, the second plurality of reactants including:
the acetyl sulfate product and polystyrene (PS), wherein the molar ratio of SA to PS repeat units is between about 0.2 and about 0.30;
reacting the second plurality of reactants at about 39.6° C. for 1 hour;
transferring the second plurality of reactants to a water bath at a temperature above about 80° C. to form a PS-r-SPS-H product;
contacting the PS-r-SPS-H product with an excess concentration of an alkali hydroxide to form a PS-r-SPS-Y product, wherein Y is an alkali metal;
preparing a production solution of PS-r-SPS-Y product and dimethyl acetamide; and
casting an ion-exchange membrane from the production solution.
